(19) United States
(12) Patent Application Publication
(10) Pub. No.: US 2008/0211199 A1
(43) Pub. Date: Sep. 4, 2008

(54) Snow Vehicle

(76) Inventor: Dae-Youn Kim, Gyeonggi-do (KR)

Correspondence Address: FRANKLIN & ASSOCIATES INTERNATIONAL LLC, 230 St. Francis Drive, Suite 1, SANTA FE, NM, 87505-3538, US

(21) Appl. No.: 11/995,930

(22) PCT Filed: Mar. 29, 2006
(86) PCT No.: PCT/KR2006/001151

§ 371 Date: Jan. 16, 2008

(30) Foreign Application Priority Data
Aug. 25, 2005 (KR) 20-2005-0024460

(51) Int. Cl. B62B 17/02

(52) U.S. Cl. 280/22.1

(57) ABSTRACT

A snow vehicle according to the present invention takes a shape streamlined from a front part 110 to a rear part 130, which makes the snow vehicle look like a chamfered rhombus or a diamond in overall. Herein, the snow vehicle comprises: a main body 100 formed with a pair of lower body holders 140 protruding upward on opposite sides of the main body 100 on a portion where the user's lower body touches the main body 100 and being streamlined in shape of letter “U”; and a pair of sliders 200 contacting the ground and being extended from a first end, which is coupled with the main body 100 by a coupling means 210 vertically connected to the front part 110 of the main body 100, to a second end. The snow vehicle according to the present invention has an advantage that an inexperienced novice, a handicapped person, and a skilled person can enjoy thrilling speeding experience with conveniency, by combining advantages of the ski and the sled.

### TECHNICAL FIELD

The present invention relates to a snow vehicle, and more particularly to a snow vehicle capable of enabling a user to control a moving direction and an angle of sliders with the user's hands while the user is in a prone position in which the user's upper body is facing the moving direction of the snow vehicle to maximize the user's thrilling speeding experience, unlike a conventional snow vehicle equipped with wheels.

### BACKGROUND ART

A sled is an apparatus provided with an additional means such as a plate or a blade on the bottom thereof to diminish a friction with the ice or snowy field. The sled functions as one kind of leisure or transportation by allowing a user to position himself/herself on a plate and to navigate on a horizontal or slanted ice field with a certain speed. Accordingly, various types of the sled have been used in various countries over a significant period of time.

However, Korean patent publication or Korean utility model publication already disclosed various types of sleds including, as an example, a type enabling a user to sit on the sled, a type equipped with wheels on a bottom surface, a type combined with sliders, and a type combined with bicycle wheels.

Particularly, the type of sled combined with the sliders, which has a pair of sliders on the bottom, includes various modified types, varying from a type of a motorized structure to a type of modified slider structure. However, such a conventional type of sled combined with the sliders takes a structure allowing a user to sit on the plate of the sled, or to take a posture in which the user's legs are placed on the front.

### DISCLOSURE OF INVENTION

### Technical Problem

However, To ensure user's safety against relative high speed of the sled, it was necessary for the conventional sled such as the type of sled combined with the ski to take a structure of only allowing the user to place his/her legs on the front. Although such conventional sleds have been satisfactorily utilized in a children's sled range, yet the conventional sled has a disadvantage that skiers or adult sled users who wish for more speeding experience cannot fully enjoy the speed of sled due to air friction due to a posture in which the user's legs are positioned on the front.

In addition, the user has to apply force against an ice surface or a snowy ground using the user's legs if the user wants to reduce the speed of the sled while riding the sled. However, such a method of controlling speed becomes an additional disadvantage because the speed cannot be controlled properly in such an uncomfortable method.

Besides, the course of navigation becomes uncertain disadvantageously as the conventional sled is not properly provided with a separate means to control the moving direction. In addition, a handicapped person who has difficulty in using his les cannot use such conventional sleds, speed of which can be controlled only by the legs.

If the user can ride the sled in a posture of lying prone so that the upper body is place on the front, it will be advantageous not only that the user can maximize the speeding experience with thrill, but also that the handicapped person with a disability of legs can enjoy riding sled comfortably.

Accordingly, there exists a demand for an improved structure of sled allowing the user to place the user's upper body on the front, so that not only skiers or adult sled users but also the handicapped persons with leg disability can have more fun from riding the sled, while ensuring the user's safety and providing thrilling speeding experience at the same time.

### TECHNICAL SOLUTION

The present invention is devised to solve such a problem mentioned above. An objective of the present invention is achieved by providing a snow vehicle of structure provided with a pair of sliders on the bottom thereof so that a user's upper body is placed on the front of the snow vehicle.

Another objective of the present invention is achieved by providing a means to control a moving direction and a speed of the sliders with the user's hand.

Another objective of the present invention is achieved by providing a snow vehicle structure having a plate ergonomically designed to prevent the user's body being separated from the main body, and by additionally providing a means to fix the user's body on the main body.

### ADVANTAGEOUS EFFECTS

As describe above, a snow vehicle according to the present invention has an advantage that an inexperienced novice, a handicapped person, and a skilled person can enjoy thrilling speeding experience with conveniency, by combining advantages of the ski and the snow vehicle.

In addition, the present invention has additional advantages that the user's body can be supported properly on the main body while riding, the user can be better prepared for the accident that can be caused by inadvertence during riding because the user's body can be separated easily from the snow vehicle in case of emergency, and that the user can conveniently control the speed and the moving direction of the snow vehicle.

### BRIEF DESCRIPTION OF THE DRAWINGS

These and/or other aspects and advantages of the present invention will become apparent and more readily appreciated from the following description of the aspects, taken in conjunction with the accompany drawings of which:

FIG. 1 is a perspective view illustrating overall structure of a snow vehicle according to the present invention.

FIG. 2 is a perspective view illustrating a side of the snow vehicle according to the present invention.

FIG. 3 is a side view of the snow vehicle according to the present invention.

FIG. 4 is a plane view of the snow vehicle according to the present invention.

FIG. 5 is a front view of the snow vehicle according to the present invention.

FIG. 6 shows an illustrative usage of the snow vehicle according to the present invention.

FIG. 7 is a side view showing an illustrative usage of the snow vehicle according to the present invention.

FIG. 8 is a perspective view of the snow vehicle, having a lower body fixing part, according to the present invention.

FIG. 9 is an exploded perspective view of an another embodiment of a coupling means of the snow vehicle according to the present invention.

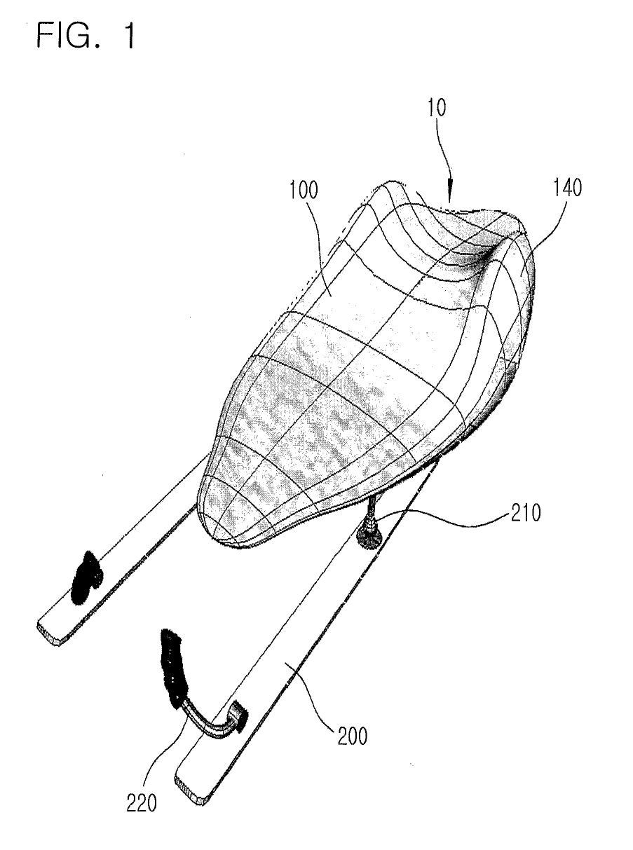

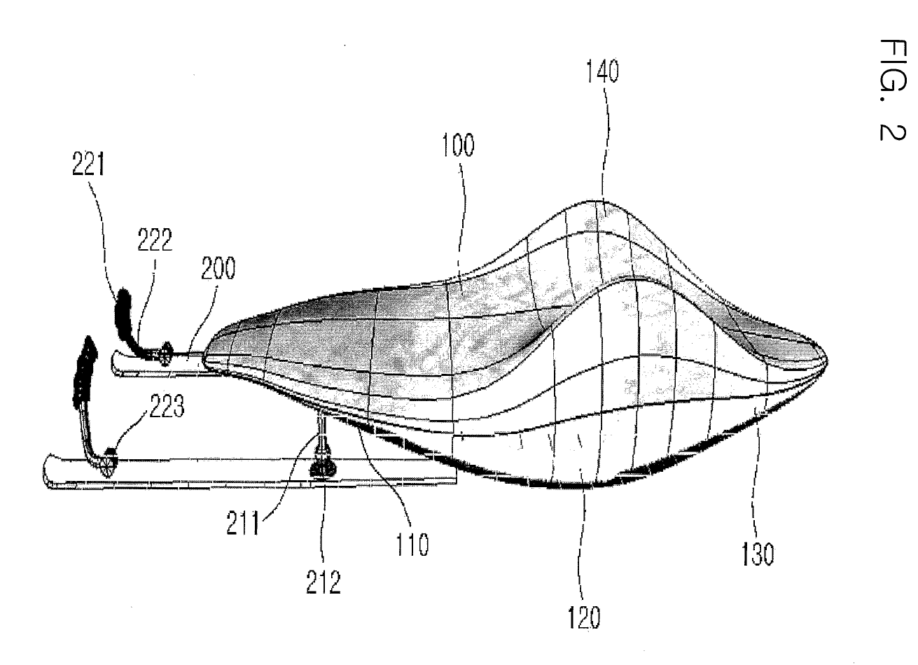

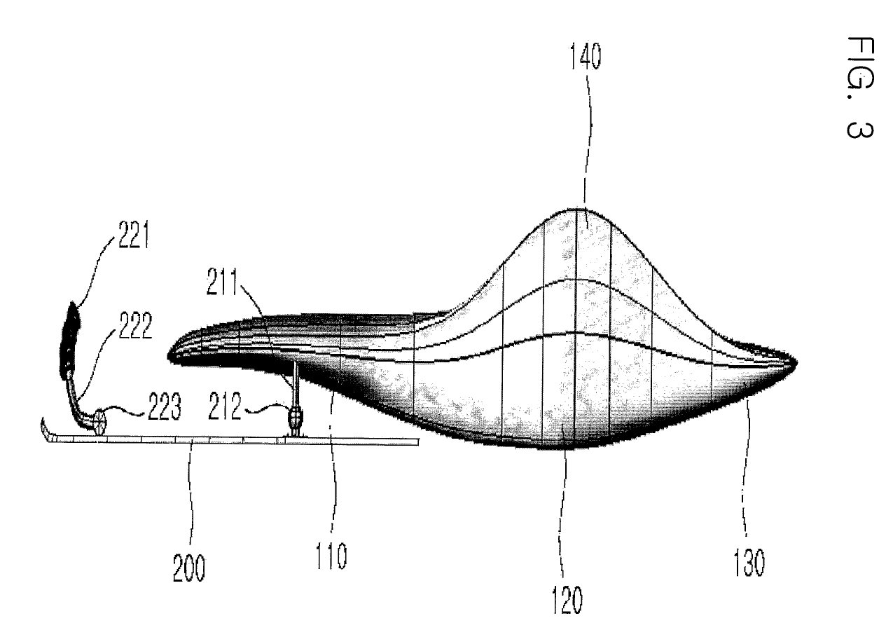

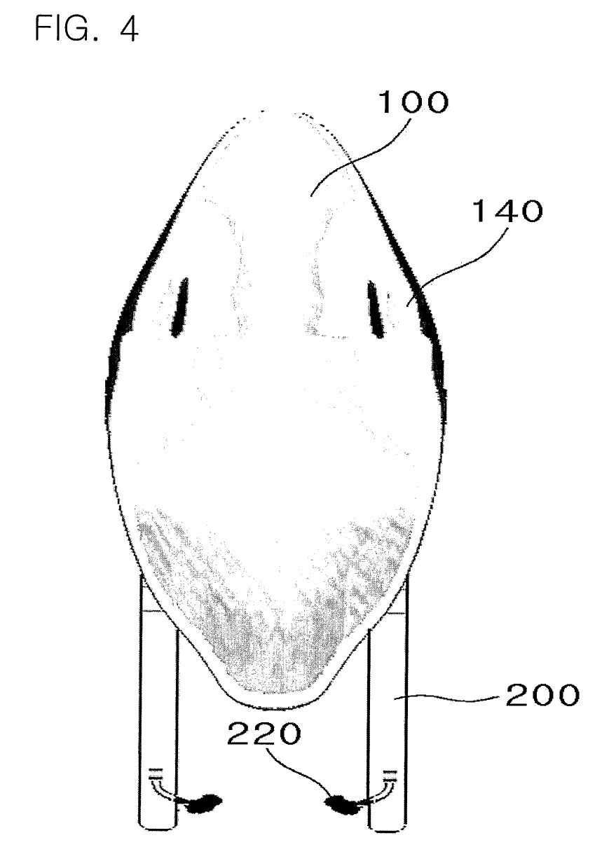

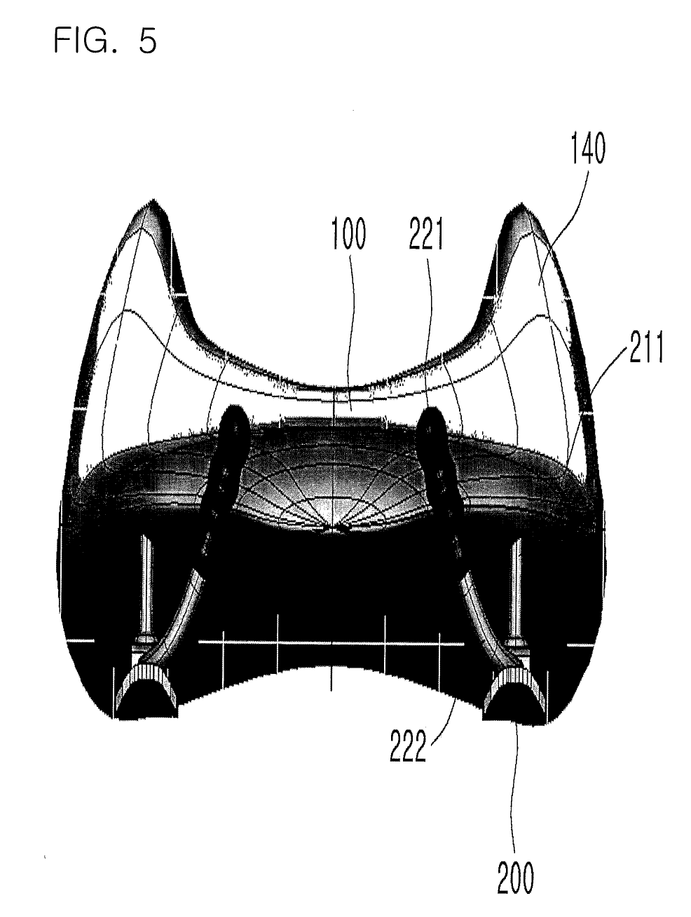

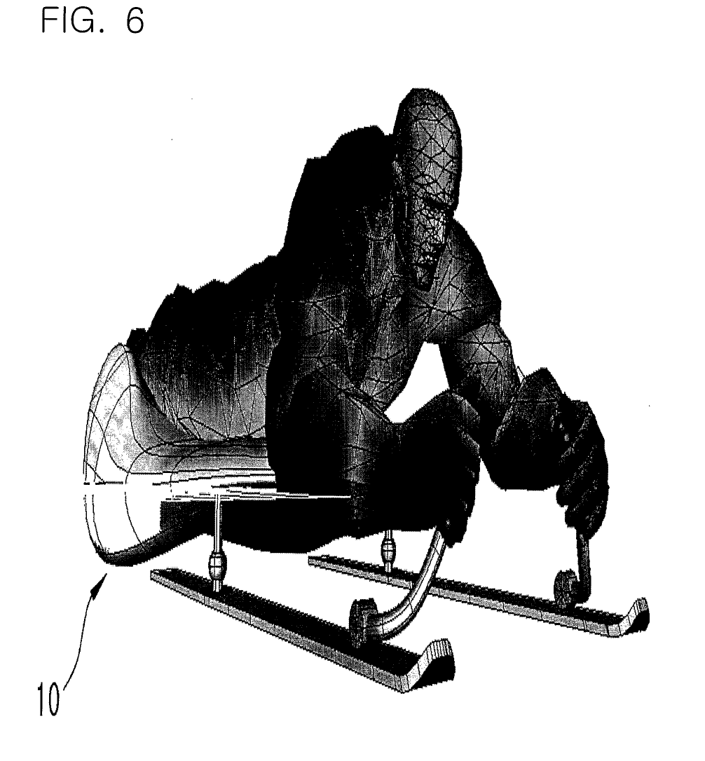

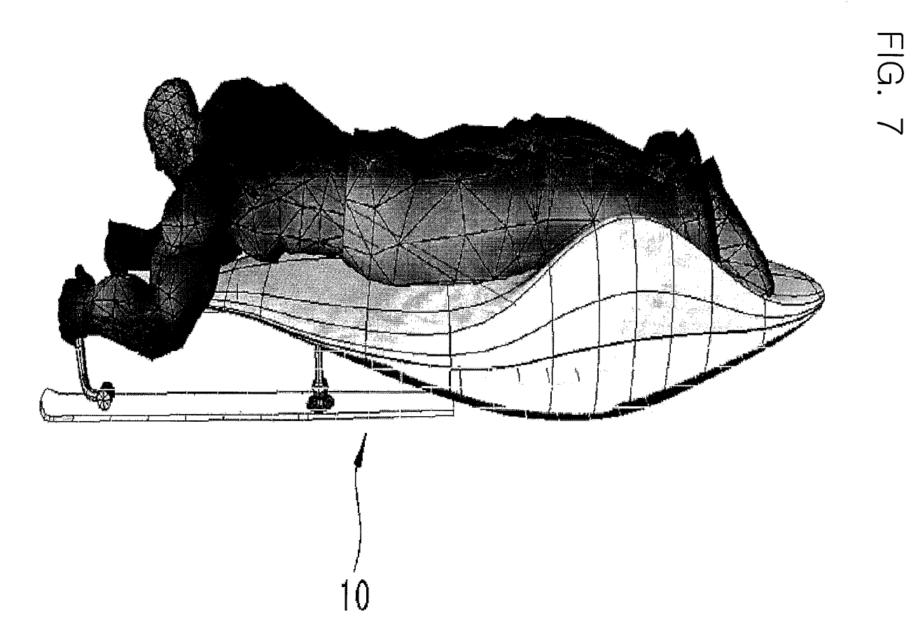

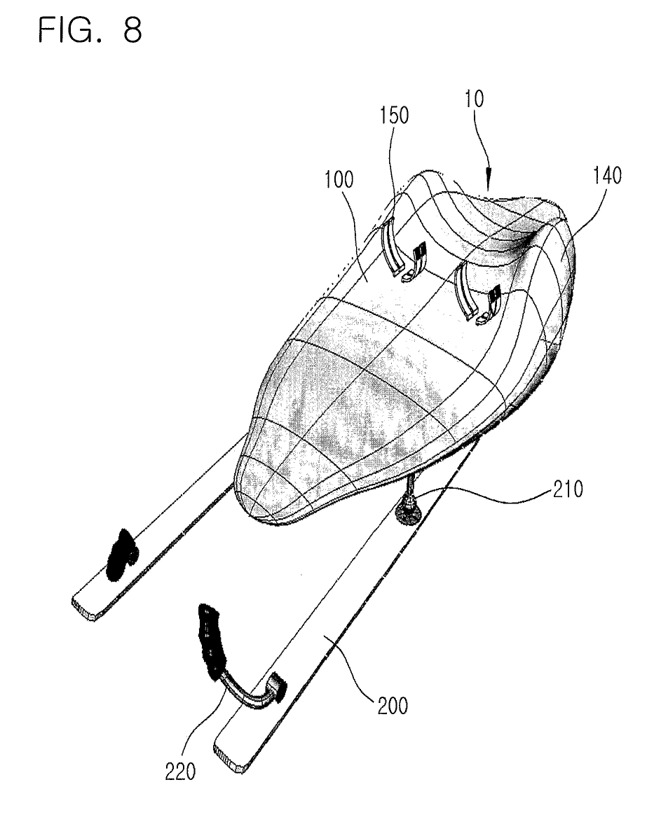

### BEST MODE FOR CARRYING OUT THE INVENTION

it is an aspect of the present invention to provide a snow vehicle, characterized by comprising: a main body 100 formed with a pair of lower body holders 140 protruding upward on opposite sides of the main body 100 on a portion where the user's lower body touch the main body 100; a pair of sliders 200 extending longitudinally with a certain length on a bottom of the main body 100; a coupling means 210 coupling the pair of sliders 200 and the main body 100 in order to enable the pair of sliders 200 to rotate vertically and horizontally within a certain range; and a handle 220 provided on a side of the sliders 200 and controlling a moving direction of the sliders 200, wherein the user can control the moving direction and the speed of the sliders 200 by controlling the handle 220 with the user's hands while the user is in prone position on the main body 100 facing the front.

Additional aspects and advantages of the invention will be set forth in part in the description which follows and, in part, will be obvious from the description, or may be learned by practice of the invention.

### MODE FOR THE INVENTION

To achieve objectives of the present invention described above, a snow vehicle according to the present invention takes the main body of a shape being streamlined from a front part 110 to a rear part 130, which makes the snow vehicle look like a chamfered rhombus or diamond in overall. Specifically, the snow vehicle comprises: the front part 110 detached from the ground and being extended from a bottom-contacting part to a front end of the main body with an inclination; a bottom-contacting part 120 being streamlined and extended from the front part 110 and contacting the ground; a rear part 130 being streamlined and extended upward from the bottom-contacting part 120 with an inclination; a main body 100 formed with a pair of lower body holder 140 protruding upward on opposite sides of the main body 100 and being streamlined in curvature to form a shape similar to letter ‘U’ in which a user's lower body can fit; and a pair of sliders 200 contacting the ground and being extended from a first end, which is coupled with the main body 100 by a coupling means 210 vertically connected to the front part 110 of the main body 100, to a second end. Herein, the sliders 200 comprises: a coupling bar 211 vertically extending from the front part 110 of the main body 100; a coupling means 210 including a rotating part 212 placed between the coupling bar 211 and the sliders 200 and coupled with the coupling bar 211 in order to enable the sliders 200 to rotate vertically and horizontally within a particular range; a lever 221 that the user can grip; a handle 220 including a connecting bar 222 connected with the lever 221 and a fixing means 223 combined on a top surface of the sliders 200. Further, the snow vehicle according to the present is characterized in that the user can control a moving direction and a speed of the sliders 200 by controlling the navigation mean 220 while the user is in prone position facing forward on the main body 100.

Reference will now be made in detail to the aspects of the present invention, examples of which are illustrated in the accompanying drawings, wherein like reference numerals refer to like elements throughout. The aspects are described below in order to explain the present invention by referring to the figures.

As shown in the drawings, the snow vehicle 10 according to the present mainly comprises the main body 100 supporting the user's body and the sliders 200 provided on a bottom of the main body 100.

An appearance of the main body 100 according to the present invention may be described as that the main body 100 is streamlined, similarly to a water ski board, extending from the front part 110 to the rear part 130 and that edges are rounded to be in shape of a chamfered or filetted rhombus or diamond. However, the main body 100 may take a modified shape such as a triangle or other kind of polygon. The main body 100 is conveniently configured so that the user's head and torso can be placed on the front part 110 which is a front portion of the main body 100 and the user's legs or lower body can be placed on the bottom-contacting part (or middle part) 120 and the rear part 130, which are remaining portion excluding the front part 110 of the main body 100.

Hereinafter, the main body 100 according to the present invention will be described in reference with the side view. The front part 110 which takes approximately 30 to 40% of whole length of the main body 100 extends from the front end to the bottom surface with an inclination so that the front part 110 is designed to be off the ground. So, to prevent the front part 110 from contacting the ground, the bottom of the front part 110 is supported by the coupling means 210 of the sliders 200 which will be described later.

The front part 110 extends to the middle part of the main body 100 which is designed to contact the ground, that is an ice surface or a snowy ground. The main body 100 according to the present invention is formed with curvature to streamline the whole body and the shape of the snow vehicle is designed with intention to minimize a portion contacting the ground to reduce the friction with the ground. Hereinafter, the middle part of the main body 100 is referred to as “bottom-contacting part” 120.

The user may have a difficulty in controlling a moving direction or a speed of the sliders that is described later if the bottom-contacting part 120 is linearly designed as a straight shape, not being streamlined, which increases the surface contacting the ground. Therefore, It is preferable that the bottom-contacting part 120 is designed as a streamlined structure as possible as shown in the drawings.

The rear part 130 extending from the bottom-contacting part 120 preferably takes 20 to 30% of length of the main body 100 and is extended upward from the bottom-contacting part 120 not to contact the ground.

Such a streamlined structure allowing only the bottom-contacting part 120 to contact the ground is an optimized structure to minimize the friction with the ground caused by the main body 100 supporting the weight of the user's body and to prevent the main body 100 from being tilted to side ways unnecessarily or being unstable when the weight of the user's body is not balanced well.

The main body 100 having such property is made of reinforced plastics to have tolerance against percussion.

Additionally, it is shown in the side view of the main body 100 that the main body 100 is formed with the pair of lower body holder 140 protruding upward on opposite sides of the main body 100 and being streamlined in curvature to form a shape similar to letter ‘U’ on a portion where the user's legs or lower body touch the main body 100.

Even though the user's upper body can be supported on the main body 100 considerably by gripping on the lever 221 when the user rides the snow vehicle, the lower body wouldn't be held properly without any proper holding means. Accordingly, the lower body holder 140 is devised to properly prevent the user's lower body from deviating out of the main body 100 by a slight percussion.

Herein, if the user's lower body is held on the main body 100 with a stronger holding means such as a tie-down, the user may be endangered in case of accident as the user's body cannot be separated easily from the snow vehicle 10. In other words, if the user is firmly held on the main body 100, the user's body cannot be separated from the main body 100 in an accident, thereby causing more serious impact on the user. In such aspect, the snow vehicle 10 according to the present invention provides the user with safety by allowing the user to be separated from the main body 100 in case of a dangerous percussion while holding the user's lower body on the main body 100 properly in other cases, all of which can be realized by the lower body holder 140.

In other words, in case the main body 100 is cradled within a tolerable range as the snow vehicle drives on a curved path or on a roughed snowy ground, the pair of lower body holder 140 protruding on opposite sides as a pair functions as a threshold to prevent the user's lower body from deviating out of the main body 100. However, in case of serious accident such as collision with an object, the user's legs can be easily separated from the snow vehicle 10 as the impact will cause the user's legs to slip easily out of the lower body holder 140 which is shaped in streamline. In this manner, the present invention ensures the user's safety in all situations.

However, the main body 100 according to the present invention may be additionally provided with a lower body fixing part 150 on a rear portion of the main body 100.

That is, to offer more safety for users who are inexperienced with or afraid of the inclined snowy grounds, various coupling means such as hook, button, or zipper can be employed additionally other than the lower body holder 140. However, the lower body fixing part 150 is preferably provided as a pair of rings made of easily removable velcro tape for the purpose of achieving protecting the user from a percussion and releasing the user over a certain degree of percussion.

The lower body fixing part 150 functions to prevent the user's legs from unnecessarily moving and to fix the user's legs on the main body 100 by binding the user's legs and closing/combining open ends of ring.

Additionally, the lower body fixing part 150 may modify combining portions in connection with the user's robe. Although it is not shown on the drawings, as an example, a particular portion of the user's robe (such as safety clothing made of shock absorption material) is provided with a coupling part attached with velcro tape, while a portion of the main body corresponding to the position of the coupling part is provided with another coupling part attached with velcro tape. In this manner, it is possible to provide an inexperience user such as novice with a method to fix the user's body on the main body 100 more safely.

The sliders 200 according to the present invention is structured as a pair of blades extending from the rear to the front in parallel with the front tips of blades bent upward slightly like the conventional ski.

The sliders 200 extends frontward from near the bottom-contacting part 120 of the main body 100 or a portion of the front part 110 in a certain length passing the front end of the main body 100. Also, the sliders 200 is provided with the coupling means 210 for combining with the main body 100.

The coupling means 210 functions to firmly combine the sliders 200 and the main body 100, and comprises: the coupling bar 211 vertically extending from a rear end of the sliders 200 toward the main body 100; and the rotating part 212 coupled with the coupling bar 211 in order to enable the sliders 200 to rotate vertically and horizontally within a particular angle.

A top of the rotating part 212 forms a groove that can accept an end of the coupling bar 211. The rotating part 212 is a case shaped like a sphere including already-disclosed components for rotatable axial bond such as a ball bearing and joints to be combined with an axis from the end of the coupling bar 211. The rotating part 212 functions to enable the sliders 200 to rotate/move vertically and horizontally within a range of specific angle. Specifically, the rotating part 212 enables the sliders 200 to rotate left and right within a specific angle according to how a user manipulates the handle 220 and to move up and down as the impact from the snowy ground is transferred to the snow vehicle 10 while the snow vehicle 10 is moving.

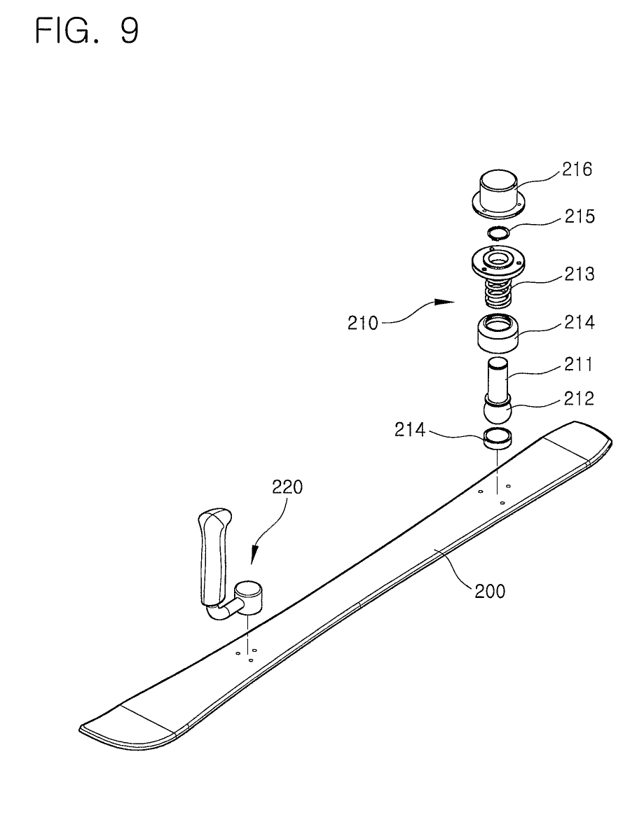

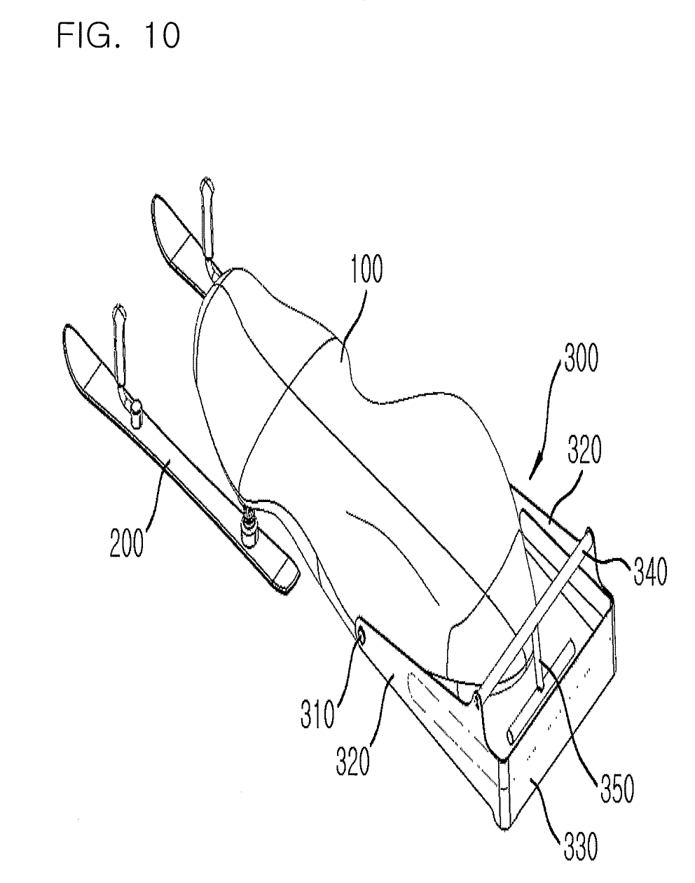

FIG. 9 is an exploded perspective view illustrating another embodiment of the coupling means according to the present invention. The coupling means 210 according to the present invention also includes the coupling bar 211 and the rotating part 212 described above. Specifically, the coupling bar 211 comprises a proper number of bearings (ball bearings) 214, shock absorber 213, packing 215, and top coupling means 216. That is, the top coupling means 216 is coupled to the main body 100, then it is coupled/combined with the coupling bar 211 positioned below. Herein, the bearing 214 and the packing 215 are provided on a proper position of coupling portion. The shock absorber 213 functions to absorb/prevent a shock caused by the elasticity of the spring included in the shock absorber 213, wherein the shock absorber 213 may be provided on one side of the coupling bar 211 or may be included as one component of coupling bar 211.

The handle 220 according to the present invention is mounted as a pair on a portion of the front end of the sliders 200, which is a portion reachable by user's hands, and it comprises the lever 221 gripped by the user's hands, the connecting bar 222 extending to the sliders 200, and the fixing means 223 combined with the sliders 200.

The lever 221 is made of synthetic resin material to prevent the user's grip from slipping. The connecting bar 222 functions to connect the fixing means 223 and the lever 221 in middle, and is bent inward ergonomically in curvature in order to enable the user not only to have a grip conveniently but also to control the sliders 200 easily by applying force.

In other words, the lever 221 and the connecting bar 222 of the handle 220 are bent inward in a certain angle, when seen from the front, so that the user can easily grip and apply force to the lever 221.

The fixing means 223 functions to fix the handle 220 on the sliders 200 firmly. However, it does not have any particular structure such as hinge or bearing bond to fix the handle 220 on the sliders 200.

With such structure of handle 220, the user can not only support his/her upper body by gripping the handle 220 during riding, but also control the rotating part 212 of the coupling means 210 by pushing and pulling the handle 220 in side ways so that the sliders 200 can be lifted from the ground in a certain angle and adjusted in a direction in which the user wish to proceed. In this way, the user control set proceeding direction arbitrarily, and at the same time, he can reduce or stop the speed by pulling the handle 220 toward inside to make the sliders 200 form letter “A”. Because it is possible for the user to stop the snow vehicle and control a proceeding direction of the snow vehicle by controlling the handle 220 in a manner described above, even users such as a novice and handicapped people can enjoy a speeding experience conveniently, and the speeding experience can be maximized by positioning the user's upper body on the front of the snow vehicle rather than on the rear of the snow vehicle.

FIG. 10 is a perspective view of an another embodiment according to the present invention, illustrating a state of the snow vehicle 10 combined with the braking means 300 shows.

As shown in FIG. 10, the snow vehicle 10 according to the present invention further comprises the braking means 300 capable of providing more stability and applying excellent braking force.

In detail, the braking means 300 according to the present invention comprises: a pair of connection frames 320 rotatably combined to hinges 310 formed on proper positions of both sides of the main body 100 and extending (longitudinally) in parallel to the main body 100; a traversing frame 330 formed perpendicularly to the connection frames 320 and connecting ends of the connection frames 320; a bar 340 connecting parts of the connection frames 320 in parallel to the traversing frame 330; and a foot holder 350 formed extending downward from the middle of the bar 340 and preferably having a shape of reversed “T”.

The whole frame of the braking means 300 composed of the pair of connection frames 320 and the traversing frame 330 takes a shape of “□” reversed in 180 degree.

Preferably, the connection frame 320 connected to the hinges 310 extends downward slightly so that only the ends of the traversing frame 330 and the connection frame 320 can touch the snowy ground. Preferably, the connection frame 320 is formed to have a broader end in order to allow only the end of the traversing frame 330 and the connection frame 320 to touch the snowy ground.

The braking means 300 with such configuration allows the user to rotate the braking means 300 centering around the hinges 310 by placing the user's foot on the foot holder 350 to apply force downward.

The braking means 300 described above is intended to complement the braking force of the handle 220 or to additionally provide an effective braking method. Herein, the end of the connection frame 320 or the traversing frame 330 is detached from the snowy ground in case that the user applies force to lift the foot holder 350 upward. However, when the user needs braking, the user can release the foot holder 350 to allow the end of the connection frame 320 or the traversing frame 330 to touch the snowy ground, which will provide the snow vehicle 10 according to the present invention with an effective braking force using friction of the end of the connection frame 320 or traversing frame 330.

Although a few embodiments of the present invention have been shown and described, it will be appreciated by those skilled in the art that changes may be made in these aspects without departing from the principles and spirit of the invention, the scope of which is defined in the appended claims and their equivalents.

1. A snow vehicle, characterized by comprising: a main body formed with a pair of lower body holders protruding upward on left and right sides of the main body on a portion where the user's lower body touches the main body; a pair of sliders extending longitudinally with a certain length on a bottom of the main body; a coupling means coupling the pair of sliders and the main body in order to enable the pair of sliders to rotate vertically and horizontally within a certain range; and a handle provided on a side of the sliders and controlling a moving direction of the sliders, wherein the user can control the moving direction and the speed of the sliders by controlling the handle with the user's hands while the user is in prone position on the main body facing the front.

2. The snow vehicle according to claim 1, wherein the main body comprises a bottom-contacting part extending upward with an inclination to a front part and a rear part, the front part and the rear part being off the ground with a certain distance from the ground.

3. The snow vehicle according to claim 2, wherein, the main body is streamline in overall from the front part to the rear part so that the main body takes a shape similar to a rhombus or a diamond having chamfered edges.

4. The snow vehicle according to claim 1, wherein the coupling means comprises: a coupling bar vertically extending from the main body; and a rotating part axially coupled with the coupling bar in order to enable the sliders to rotate vertically and horizontally within an certain range.

5. The snow vehicle according to claim 1, wherein the coupling means further comprises a shock absorber.

6. The snow vehicle according to claim 1, wherein the handle comprises: a lever on which the user's hands are supported; a connecting bar connected vertically with the lever; and a fixing means combined on a top surface of the sliders.

7. The snow vehicle according to claim 1, wherein at least one lower body fixing part made of velcro tape in shape of a ring is additionally provided on a portion of a top surface of the main body to bind a portion of the user's body.

8. The snow vehicle according to claim 1, wherein the lever and the connecting bar of the handle are bent inwardly in a certain angle, when seen from the front.

9. The snow vehicle according to claim 2, wherein the front part takes 30 to 40% of whole length of the main body.

10. The snow vehicle according to claim 2, wherein the rear part takes 20 to 30% of whole length of the main body.

11. The snow vehicle according to claim 1, further comprising braking means comprising: a pair of connection frames rotatably combined to hinges formed on both sides of the main body and extending longitudinally in parallel to the main body; and a traversing frame connecting ends of the connection frames.

12. The snow vehicle according to the claim 11, wherein the braking means further comprises: a bar connecting parts of the connection frames in parallel to the traversing frame; and a foot holder formed on a side of the bar.

13. The snow vehicle according to the claim 12, wherein the foot holder is formed in shape of reversed “T”.
